(19) United States
(12) Patent Application Publication
(10) Pub. No.: US 2019/0048199 A1
(43) Pub. Date: Feb. 14, 2019

(54) METHOD OF MAKING HYDROPHOBIC SILICA PARTICLES

(71) Applicant: Dow Global Technologies LLC, Midland, MI (US)

(72) Inventors: Xiaomei Song, Shanghai (CN); Yuanqiao Rao, Berwyn, PA (US); Nan Hu, Shanghai (CN); Zhe Li, Shanghai (CN); Andong Liu, Shanghai (CN)

(21) Appl. No.: 16/078,918

(22) PCT Filed: Mar. 31, 2016
(86) PCT No.: PCT/CN2016/078003

§ 371 Date: Aug. 22, 2018

(51) Int. Cl. C09C 1/30; C01B 33/18

(52) U.S. Cl. CPC C09C 1/3063; C01B 33/18; B82Y 30/00; C01P 2004/52; C01P 2004/54; C01P 2004/64

(57) ABSTRACT

A method of making a plurality of non-crystalline hydrophobic silica particles, is provided, comprising: providing a plurality of hydrophilic silica particles; providing a water; providing an aldose; dispersing the plurality of hydrophilic silica particles in the water to form a silica water dispersion; dissolving the aldose in the silica water dispersion to form a combination; concentrating the combination to from a viscous syrup; heating the viscous syrup in an inert atmosphere to form a char; communicating the char to from a powder; heating the powder to form the plurality of non-crystalline hydrophobic silica particles.

The invention relates to the field of the preparation of silica particles. In particular, the invention relates to a method of making silica particles, wherein the silica particles have a uniform particle size, are non-crystalline and hydrophobic.

Silica particles have use as fillers in barrier layer film forming materials used, for example, in the electronics industry (e.g., in combination with Liquid crystal displays) to protect certain components from the environment.

Liquid crystal displays (LCDs) have been employed in ever increasing numbers since their initial development by RCA back in 1968 in a wide variety of optical devices. Given that they do not emit any light directly, LCDs are integrated with a light source to form the optical device. In more recent device designs, LCDs are integrated with light emitting diodes (LEDs) or organic light emitting diodes (OLEDs) as the light source.

A particular variant of LCD, is a thin film transistor liquid crystal display (TFT LCD). TFT LCDs are used in a wide variety of optical display devices including, computer monitors, televisions, mobile phone displays, hand held video games, personal digital assistants, navigation tools, display projectors, and electronic instrument clusters.

Thin film transistors (TFTs) are fundamental building blocks of electronic circuits that are used in, for example, both light crystal display (LCD) and organic light emitting diode (OLED) type devices. Structurally, TFTs typically comprise a supporting substrate, a gate electrode, a source electrode, a drain electrode, a semiconductor layer and a dielectric layer. Exposure to various environmental elements can negatively impact the performance of TFTs. In particular, the semiconductor layers in TFTs have transient conductivity determined by an applied gate voltage. The charge transport properties of the incorporated semiconductor layers in TFTs typically exhibit deterioration upon exposure to moisture and oxygen during use. Consequently for operational stability and extended life, TFTs require protection from such environmental elements provided through incorporation of protective barrier or encapsulation layer(s).

Incumbent TFT passivation materials (e.g., SiNₓ) are deposited using plasma enhanced chemical vapor deposition (PECVD) processing techniques. Such PECVD techniques require significant capital investment and multiple processing steps. Alternative, lower cost passivation materials and solution processed thin film passivation coatings to TFTs in both LCD and OLED display applications would be desirable to lower manufacturing costs.

One solution processed thin film passivation coating approach is disclosed by Birau et al. in U.S. Pat. No. 7,705,346. Birau et al. disclose an organic thin film transistor comprising a substrate, a gate electrode, a semiconductor layer, and a barrier layer; wherein the gate electrode and the semiconductor layer are located between the substrate and the barrier layer; wherein the substrate is a first outermost layer of the transistor and the barrier layer is a second outermost layer of the transistor; and wherein the barrier layer comprises a polymer, an antioxidant, and a surface modified inorganic particulate material.

Notwithstanding, there remains a need for alternative barrier layer compositions and components therefore, including new methods for manufacturing silica particles for use in such barrier layer compositions, wherein the silica particles have a uniform particle size, are non-crystalline and hydrophobic.

The present invention provides a method of making a plurality of non-crystalline hydrophobic silica particles having an average particle size of 5 to 120 nm and a water absorbance of <2% determined according to ASTM E1131, comprising: providing a plurality of hydrophilic silica particles; providing a water; providing an aldose; dispersing the plurality of hydrophilic silica particles in the water to form a silica water dispersion; dissolving the aldose in the silica water dispersion to form a combination; concentrating the combination to form a viscous syrup; heating the viscous syrup in an inert atmosphere at 500 to 625° C. for 4 to 6 hours to form a char; comminuting the char to form a powder; heating the powder in an oxygen containing atmosphere at >650 to 900° C. for 1 to 2 hours to form the plurality of non-crystalline hydrophobic silica particles.

### DETAILED DESCRIPTION

Non-crystalline, hydrophobic silica particles having a low average aspect ratio and a narrow particle size, PS_{avg}, distribution and a particles size of ≤120 nm, a low average aspect ratio, AR_{avg}, and a low polydispersity index, PdI, which are retained during the formation of the non-crystalline hydrophobic silica particles from hydrophilic silica particles (e.g., Stöber silica particles) have a range of uses, including use in passivated thin film transistor components designed for use in a display devices incorporating a barrier layer that includes the non-crystalline hydrophobic silica particles.

Preferably, the method of making a plurality of non-crystalline hydrophobic silica particles (preferably, wherein the plurality of non-crystalline hydrophobic silica particles have an average particle size of 5 to 120 nm (preferably, 10 to 110 nm; more preferably, 20 to 100 nm; most preferably, 25 to 90 nm) wherein the particle size is measured using well known low angle laser light scattering laser diffraction) and a water absorbance of <2% determined according to ASTM E1131) of the present invention, comprises: providing a plurality of hydrophilic silica particles (preferably, wherein the plurality of hydrophilic silica particles provided are prepared using a Stöber synthesis process); providing a water; providing an aldose (preferably, wherein the aldose provided is an aldohexose; more preferably, wherein the aldose is an aldohexose selected from the group consisting of D-allose, D-altrose, D-glucose, D-mannose, D-gulose, D-idose, D-galactose, D-talose; still more preferably, wherein the aldose is an aldohexose selected from D-glucose, D-galactose and D-mannose; most preferably, wherein the aldose is D-glucose); dispersing the plurality of hydrophilic silica particles in the water to form a silica water dispersion; dissolving the aldose in the silica water dispersion to form a combination; concentrating the combination to form a viscous syrup; heating the viscous syrup in an inert atmosphere at 500 to 625° C. for 4 to 6 hours to form a char; comminuting the char to form a powder (preferably, comminuting the char by at least one of crushing, pulverizing and grinding to form a powder); and, heating the powder in an oxygen containing atmosphere at >650 to 900° C. for 1 to 2 hours to form the plurality of non-crystalline hydrophobic silica particles.

Preferably, in the method of making a plurality of non-crystalline hydrophobic silica particles of the present invention, the plurality of non-crystalline hydrophobic silica particles produced have an average particle size. PS_{avg}, of 5 to 120 nm (preferably, 10 to 110 nm; more preferably, 20 to 100 nm; most preferably, 25 to 90 nm) wherein the particle size is measured using well known low angle laser light scattering laser diffraction and a water absorbance of <2% determined according to ASTM E1131. More preferably, in the method of making a plurality of non-crystalline hydrophobic silica particles of the present invention, the plurality of non-crystalline hydrophobic silica particles produced have an average particle size of 5 to 120 nm (preferably, 10 to 110 nm; more preferably, 20 to 100 nm; most preferably, 25 to 90 nm) and a polydispersity index, PdI, of ≤0.275 (preferably, 0.05 to 0.275; more preferably, of 0.1 to 0.25; most preferably, 0.15 to 0.2) determined by dynamic light scattering according to ISO 22412:2008; and a water absorbance of <2% determined according to ASTM E1131.

Preferably, in the method of making a plurality of non-crystalline hydrophobic silica particles of the present invention, the plurality of non-crystalline hydrophobic silica particles produced have an average aspect ratio, AR_{avg}g, of ≤1.5 determined by dynamic light scattering according to ISO 22412:2008. More preferably, in the method of making a plurality of non-crystalline hydrophobic silica particles of the present invention, the plurality of non-crystalline hydrophobic silica particles produced have an average aspect ratio, AR_{avg}, of ≤1.25 determined by dynamic light scattering according to ISO 22412:2008. Most preferably, in the method of making a plurality of non-crystalline hydrophobic silica particles of the present invention, the plurality of non-crystalline hydrophobic silica particles produced have an average aspect ratio, AR_{avg}, of ≤1.1 determined by dynamic light scattering according to ISO 22412:2008.

Preferably, in the method of making a plurality of non-crystalline hydrophobic silica particles of the present invention, the plurality of hydrophilic silica particles provided have a water absorbance of >2% determined according to ASTM E1131. More preferably, in the method of making a plurality of non-crystalline hydrophobic silica particles of the present invention, the plurality of hydrophilic silica particles provided are prepared using a Stöber synthesis process. Still more preferably, in the method of making a plurality of non-crystalline hydrophobic silica particles of the present invention, the plurality of hydrophilic silica particles provided are prepared using a Stöber synthesis process wherein the silica particles are formed via the hydrolysis of alkyl silicates (e.g., tetraethylorthosilicate) in an aqueous alcohol solution (e.g., a water-ethanol solution) using ammonia as a morphological catalyst. See, e.g., Stöber. et al., Controlled Growth of Monodisperse Silica Spheres in the Micron Size Range, JOURNAL OF COLLOID AND INTERFACE SCIENCE, vol. 26, pp. 62-69 (1968).

Preferably, in the method of making a plurality of non-crystalline hydrophobic silica particles of the present invention, the water provided is at least one of deionized and distilled to limit incidental impurities. More preferably, in the method of making a plurality of non-crystalline hydrophobic silica particles of the present invention, the water provided is deionized and distilled to limit incidental impurities.

Preferably, in the method of making a plurality of non-crystalline hydrophobic silica particles of the present invention, the aldose provided is an aldohexose. More preferably, in the method of making a plurality of non-crystalline hydrophobic silica particles of the present invention, the aldose provided is an aldohexose; wherein the aldohexose is selected from the group consisting of D-allose, D-altrose, D-glucose, D-mannose, D-gulose, D-idose, D-galactose, D-talose and mixtures thereof. Still more preferably, in the method of making a plurality of non-crystalline hydrophobic silica particles of the present invention, the aldose provided is an aldohexose; wherein the aldohexose is selected from the group consisting of D-glucose, D-galactose, D-mannose and mixtures thereof. Most preferably, in the method of making a plurality of non-crystalline hydrophobic silica particles of the present invention, the aldose provided is an aldohexose; wherein the aldose is D-glucose.

Preferably, in the method of making a plurality of non-crystalline hydrophobic silica particles of the present invention, the plurality of hydrophilic silica particles are dispersed in the water using well known techniques to form the silica water dispersion. More preferably, in the method of making a plurality of non-crystalline hydrophobic silica particles of the present invention, the plurality of hydrophilic silica particles are dispersed in the water using sonication.

Preferably, in the method of making a plurality of non-crystalline hydrophobic silica particles of the present invention, the aldose provided is dissolved in the silica water dispersion using well known techniques to form the combination. More preferably, in the method of making a plurality of non-crystalline hydrophobic silica particles of the present invention, the aldose is dissolved in the silica water dispersion using sonication to form the combination.

Preferably, in the method of making a plurality of non-crystalline hydrophobic silica particles of the present invention, the combination is concentrated using well known techniques to form the viscous syrup. More preferably, in the method of making a plurality of non-crystalline hydrophobic silica particles of the present invention, the combination is concentrated using decanting and evaporative techniques to form the viscous syrup. Most preferably, in the method of making a plurality of non-crystalline hydrophobic silica particles of the present invention, the combination is concentrated by decanting and rotary evaporating to form the viscous syrup.

Preferably, in the method of making a plurality of non-crystalline hydrophobic silica particles of the present invention, the viscous syrup is heated in an inert atmosphere at 500 to 625° C. for 4 to 6 hours to form the char. More preferably, in the method of making a plurality of non-crystalline hydrophobic silica particles of the present invention, the viscous syrup is heated in an inert atmosphere at 500 to 625° C. for 4 to 6 hours to form the char; wherein the inert atmosphere is selected from the group selected from a nitrogen atmosphere, an argon atmosphere and a mixture thereof. Still more preferably, in the method of making a plurality of non-crystalline hydrophobic silica particles of the present invention, the viscous syrup is heated in an inert atmosphere at 500 to 625° C. for 4 to 6 hours to form the char; wherein the inert atmosphere is selected from the group selected from a nitrogen atmosphere and an argon atmosphere. Most preferably, in the method of making a plurality of non-crystalline hydrophobic silica particles of the present invention, the viscous syrup is heated in an inert atmosphere at 500 to 625° C. for 4 to 6 hours to form the char; wherein the inert atmosphere is a nitrogen atmosphere.

Preferably, in the method of making a plurality of non-crystalline hydrophobic silica particles of the present invention, the char is comminuted using well known techniques to form the powder. More preferably, in the method of making a plurality of non-crystalline hydrophobic silica particles of the present invention, the char is comminuted by at least one of crushing, pulverizing, milling and grinding to form the powder. Most preferably, in the method of making a plurality of non-crystalline hydrophobic silica particles of the present invention, the char is comminuted by crushing to form the powder.

Preferably, in the method of making a plurality of non-crystalline hydrophobic silica particles of the present invention, the powder in an oxygen containing atmosphere at >650 to 900° C. for 1 to 2 hours to form the plurality of non-crystalline hydrophobic silica particles. More preferably, in the method of making a plurality of non-crystalline hydrophobic silica particles of the present invention, the powder in an oxygen containing atmosphere at >650 to 900° C. for 1 to 2 hours to form the plurality of non-crystalline hydrophobic silica particles; wherein the oxygen containing atmosphere is air.

Some embodiments of the present invention will now be described in detail in the following Examples.

### Examples 1-5

### Preparation of Plurality of Hydrophilic Silica Particles

A plurality of hydrophilic silica particles was prepared in each of Examples 1-5 using the following procedure. Deionized water and an aqueous ammonia solution (0.5 molar) in the amounts noted in TABLE 1 were weighed into a 250 mL beaker with a stir bar. The contents of the beaker were allowed to stir for a minute before adding to the beaker either a solution of tetraethylorthosilicate and ethanol (Examples 1-2) or as noted in TABLE 1 to the beaker. The beaker was then sealed with plastic film and the contents were allowed to stir for the reaction time noted in TABLE 1. The contents of the beaker were then centrifuged. The supernatant was removed and the solid sediment was smashed with a lab spoon. The product plurality of hydrophilic silica particles was then triple washed with water and then dried in an oven at 150 to 200° C. for 5 hours. The average particle size of the product plurality of hydrophilic silica particles was then determined by dynamic light scattering according to ISO 22412:2008. The average particle size for the product plurality of hydrophilic silica particles prepared in each of Examples 1-5 is reported in TABLE 1

TABLE 1

| | | 0.5M | TEOS - Ethanol Solution | | | | |
|---|---|---|---|---|---|---|---|
| | DI | Aqueous | 1M | | | Stir | Avg. |
| | water | NH₃Solution | solution | TEOS | Ethanol | Time | PS |
| Ex # | (g) | (g) | (mL) | (g) | (g) | (hr) | (nm) |
| 1 | 1.05 | 3.41 | 20 | — | — | 5.5 | 60.4 |
| 2 | 1.05 | 3.41 | 50 | — | — | 6.0 | 66.8 |
| 3 | 1.05 | 3.41 | — | 21.2 | 57.2 | 24 | 84.7 |
| 4 | 6.45 | 3.41 | — | 21.2 | 53.0 | 24 | 182.6 |
| 5 | 2.09 | 6.81 | — | 42.3 | 114 | 24 | 79.6 |

### Example 6

### Preparation of Plurality of Non-Crystalline Hydrophobic Silica Particles

A plurality of non-crystalline hydrophobic silica particles was prepared from a plurality of hydrophilic silica particles prepared according to Example 4 using the following procedure. A sample of the plurality of hydrophilic silica particles (1.8 g) prepared according to Example 4 was dispersed with sonication into 100 mL of deionized water to form a dispersion. To the dispersion was then added a glucose (28 g) with sonication to form a combination. The combination was then concentrated in a rotary evaporator to form a viscous syrup. The viscous syrup was then heated in a tube furnace at 600° C. for 5 hours under a nitrogen atmosphere to provide a black foam like material. The black foam like material was then ground with agate mortar and then heated at 800° C. for 1.5 hours under air in a muffle furnace to produce the plurality of non-crystalline hydrophobic silica particles. The plurality of non-crystalline hydrophobic silica particles had a density of 2.63 g/cm³, a water solubility of 1.1 wt % and a weight loss of 0.04 wt % at 300° C. for 1 hour.

### Examples 7-8

### Preparation of Plurality of Non-Crystalline Hydrophobic Silica Particles

A plurality of non-crystalline hydrophobic silica particles was prepared from a plurality of hydrophilic silica particles prepared according to Example 5 using the following procedure. In each of Examples 7-8, a sample of the plurality of hydrophilic silica particles (1.8 g) prepared according to Example 5 was dispersed with sonication into 100 mL of deionized water to form a dispersion. To the dispersions was then added a glucose in the amount noted in TABLE 2 with sonication to form combinations. The combinations were then concentrated in a rotary evaporator to form viscous syrups. The viscous syrups were then heated in a tube furnace at 600° C. for 5 hours under a nitrogen atmosphere to provide a foam like material. The foam like material was then ground with agate mortar and then heated at 800° C. for 1.5 hours under air in a muffle furnace to produce the plurality of non-crystalline hydrophobic silica particles.

### Examples 9-12

### Particle Size and Distribution Analysis

Pluralities of non-crystalline hydrophobic silica particles formed according to Examples 7-8 were then dispersed in organic solvents as identified in TABLE 2 to form dispersions. The average particle size and polydispersity index for the plurality of non-crystalline hydrophobic silica particles were measured by dynamic light scattering according to ISO 22412.2008 using a Malvern Instruments Zetasizer. The results are provided in TABLE 2.

TABLE 2

| | Plurality of | | Average | |
|---|---|---|---|---|
| | non-crystalline | | Particle | Polydispersity |
| | hydrophobic | | Size | Index |
| Ex. | silica particles | Solvent | PS_{avg} (nm) | PdI |
| 9 | Ex. 7 | Ethanol | 138 | 0.192 |
| 10 | Ex. 7 | Acetone | 86 | 0.195 |
| 11 | Ex. 8 | Ethanol | 146 | 0.192 |
| 12 | Ex. 8 | Acetone | 115 | 0.163 |

We claim:

1. A method of making a plurality of non-crystalline hydrophobic silica particles having an average particle size of 5 to 120 nm and a water absorbance of <2% determined according to ASTM E1131, comprising:
providing a plurality of hydrophilic silica particles;
providing a water;
providing an aldose:
dispersing the plurality of hydrophilic silica particles in the water to form a silica water dispersion;
dissolving the aldose in the silica water dispersion to form a combination;
concentrating the combination to form a viscous syrup;
heating the viscous syrup in an inert atmosphere at 500 to 625° C. for 4 to 6 hours to form a char;
comminuting the char to form a powder;
heating the powder in an oxygen containing atmosphere at >650 to 900° C. for 1 to 2 hours to form the plurality of non-crystalline hydrophobic silica particles.

2. The method of claim 1, wherein the plurality of non-crystalline hydrophobic silica particles have an average particle size, PS_{avg}, of 5 to 120 nm; an average aspect ratio, AR_{avg}, of ≤1.5 and a polydispersity index, PdI, of ≤0.275 determined by dynamic light scattering according to ISO 22412:2008.

3. The method of claim 1, wherein the plurality of hydrophilic silica particles provided are prepared using a Stöber synthesis process.

4. The method of claim 1, wherein the aldose provided is an aldohexose.

5. The method of claim 1, wherein the aldose is an aldohexose selected from the group consisting of D-allose, D-altrose, D-glucose, D-mannose, D-gulose, D-idose, D-galactose, D-talose.

6. The method of claim 1, wherein the aldose is an aldohexose selected from D-glucose, D-galactose and D-mannose.

7. The method of claim 1, wherein the aldose is D-glucose.

8. The method of claim 1, wherein the inert atmosphere is selected from a nitrogen atmosphere, an argon atmosphere and a mixture thereof.

9. The method of claim 1, wherein the inert atmosphere is a nitrogen atmosphere.

10. The method of claim 1, wherein the oxygen containing atmosphere is air.
